(19) United States
(12) Patent Application Publication
(10) Pub. No.: US 2013/0076756 A1
(43) Pub. Date: Mar. 28, 2013

(54) DATA FRAME ANIMATION

(71) Applicant: Gary A. Pritting, Issaquah, WA (US)

(72) Inventor: Gary A. Pritting, Issaquah, WA (US)

(73) Assignee: Microsoft Corporation, Redmond, WA (US)

(21) Appl. No.: 13/245,872

(22) Filed: Sep. 27, 2011

(51) Int. Cl. G06T 13/00

(52) U.S. Cl. 345/473

(57) ABSTRACT

Data can be received from a first data source that is a first type of data source, and data can be received from a second data source that is a second type of data source. Data frames can be processed to produce an animation representation that represents the data frames. The data frames can include the data from the first data source and the data from the second data source. The animation representation can include one or more key animation frames that each defines a full graphical representation of one of the data frames. The animation representation can also include one or more delta animation frames that each defines one or more graphical updates without defining a full graphical representation of one of the data frames. The animation representation may be sent to a rendering environment for rendering.

### BACKGROUND

It is often difficult to see patterns in data that changes in a sequence, such as data that changes over time. For example, sales data may exhibit some seasonality (e.g., higher in the summer than in the winter). A solution to this problem is to animate a visual representation of the data as the data changes. For example, graphical elements on a chart may represent the data, and the animation may show the graphical elements changing to represent changes in the data.

### SUMMARY

The tools and techniques described herein relate to animations that represent data frames. For example, the tools and techniques may include multi-source data frame animation and/or data frame animation with delta animation frames.

In one embodiment, the tools and techniques can include processing data frames to produce an animation representation that represents the data frames. The animation representation can include one or more key animation frames that each defines a full graphical representation of one of the data frames. The animation representation can also include one or more delta animation frames that each defines one or more graphical updates without defining a full graphical representation of one of the data frames. The animation representation can be sent to a rendering environment for rendering.

In another embodiment of the tools and techniques, data can be received from a first data source that is a first type of data source, and data can be received from a second data source that is a second type of data source. Data frames can be processed, where the data frames include the data from the first data source and the data from the second data source to produce an animation representation that represents the data frames. The animation representation may be sent to a rendering environment for rendering.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a block diagram of a data frame animation environment.

FIG. 3 is an illustration of an example of an animation view.

FIG. 4 is flowchart of a technique for data frame animation with delta animation frames.

FIG. 5 is a flowchart of a technique for multi-source data frame animation.

FIG. 6 is a flowchart of a technique for multi-source data frame animation with delta frames.

### DETAILED DESCRIPTION

Embodiments described herein are directed to techniques and tools for improved animations of data frames. Such improvements may result from the use of various techniques and tools separately or in combination.

Such techniques and tools may include using delta animation frames in the animation representation. With such delta frames, the processing of graphical elements may be limited to those that change as a result of changes between data frames. In processing the data, it can be determined which of the graphical elements are to change in the next graphical frame of the animation representation (the delta animation frame). View validation for the animation can be simplified so that a view object, which is generating an animation representation, is aware of what graphical elements have changed between frames, and only updates those graphical elements. A delta frame may represent the changed graphical elements in any of various ways, such as by representing one or more final values to represent the graphical features (e.g., the size, color, position, etc. of a graphical element), and/or by representing one or more differences in values from one frame to another. The changed and/or unchanged graphical elements can include graphical elements that represent the data. The graphical elements may also include background graphical elements, such as plot area shapes, chart axes, labels, etc. The layout of graphical elements may be done incrementally so that only the background graphical elements that have changed need to be updated, and delta frames may avoid including a full definition of the graphical elements of the animation frame.

Using delta animation frames can improve performance, especially when animating large datasets that change over time. View validation for such animations can take a long time if the validation involves visiting and processing an entire graphics representation (such as a tree of graphics elements) to determine which graphical elements have actually changed between frames. The use of delta frames can allow some resource-intensive operations (e.g., retesselation of meshes for three-dimensional graphical objects) to be avoided if the corresponding graphical elements are not to be updated. Similarly, transmitting an animation representation that fully defines all graphical elements in each frame can consume significant resources. A delta animation frame may include less information than would a key animation frame for the same graphical features.

The techniques and tools may include acquiring multiple datasets from different types of sources. For example, datasets may be acquired from different types of spreadsheet files, from different types of databases, etc. An animation such as a data-driven chart can represent data from multiple sources, including different types of sources. For example, this may include retrieving data from different sources and translating the data into a single data format for the data frames to be represented in an animation. The reformatted data in those data frames may be sent to the same rendering environment as the animation representation so that a user can view the underlying data for the animation. Thus, data from different types of data sources can be compiled and used for data frame animation, and the data itself may also be displayed and viewed.

Accordingly, one or more substantial benefits can be realized from the tools and techniques described herein. The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

Techniques described herein may be used with one or more of the systems described herein and/or with one or more other systems. For example, the various procedures described herein may be implemented with hardware or software, or a combination of both. For example, dedicated hardware implementations, such as application specific integrated circuits, programmable logic arrays and other hardware devices, can be constructed to implement at least a portion of one or more of the techniques described herein. Applications that may include the apparatus and systems of various embodiments can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

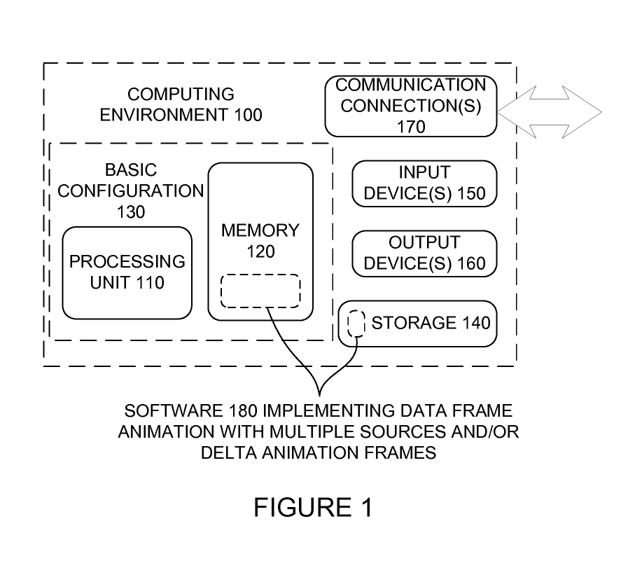

FIG. 1 illustrates a generalized example of a suitable computing environment (100) in which one or more of the described embodiments may be implemented. For example, one or more such computing environments can be used as a general animation representation generator, an animation representation translator, and/or a rendering environment. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing data frame animation with multiple sources and/or delta animation frames.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “send,” and “render” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Data Frame Animation System and Environment

A. System and Environment with General Animation Representations

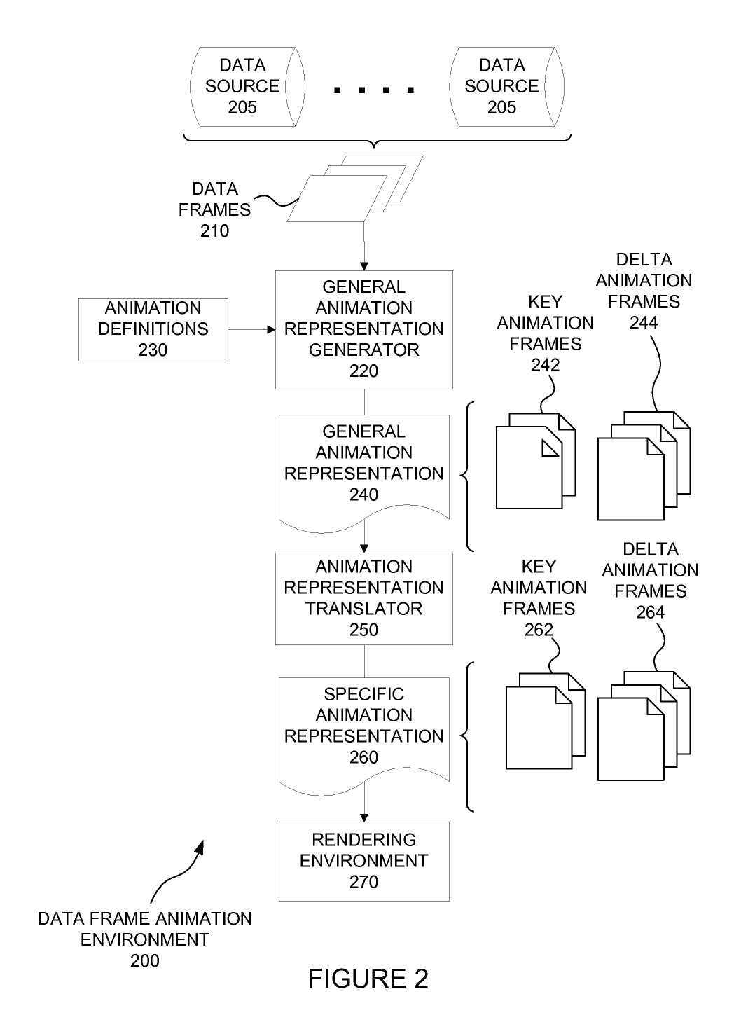

FIG. 2 is a block diagram of a data frame animation environment (200) in conjunction with which one or more of the described embodiments may be implemented. The data frame animation environment (200) can include one or more data sources (205), which can provide data frames (210) to a general animation representation generator (220). Each of the data frames (210) can include data that represents a point in time (a specific point in time, a period of time, etc.). The data in the data frames (210) may not be time-based, but may represent sequences other than set times. For example, the data frames (210) could represent data from a series of steps in a multi-step process, and the animation may represent each step as a point in time (period of time or a specific point in time) in the animation. Each frame (210) may include data from a single data source (205) or from multiple data sources (205). Also, one or more of the data frames (210) may merely indicate that there is no data from a data source corresponding to that data frame (210). The general animation representation generator (220) can receive and process data fields from different types of data sources (e.g., different types of spreadsheets, different types of databases, etc.) for use in the same data frames and/or for use in different data frames. The general animation representation generator (220) may also receive animation definitions (230) to define how the data frames (210) are to be animated. For example, the animation definitions (230) may be received from user input and/or as default settings. As examples, the animation definitions (230) may define titles, axis labels, shapes, colors, etc. for the animations. Such animation definitions (230) may also be received from one or more of the data sources (205).

The general animation representation generator (220) can process the frames (210) using the animation definitions (230) to generate a general animation representation (240). The general animation representation (240) can represent graphical features of the animation, and may also include representations of the underlying data frames (210) (which may or may not be represented in the same language as the graphical representations of the animation). As an example of the graphical representations of the animation, the general animation representation generator (220) may include one or more timelines and one or more animation actions in the general animation representation (240). The general animation representation (240) may be in a general language that is configured to be translated into any of multiple different specific languages that can represent animations.

The general animation representation (240) can be passed to an animation representation translator (250). The animation representation translator (250) can translate the general animation representation (240) into a specific language to produce a specific animation representation (260) that is configured to be used by a specific rendering environment (270). The specific animation representation (260) can be sent to the specific rendering environment (270). For example, the specific animation representation (260) may be sent over a computer network, through an application programming interface within a computing machine, or in some other manner. The rendering environment (270) can render the represented animation of the data frames (210). The rendering environment (270) could be within any of many different types of devices, such as a personal computer, a slate computer, or a handheld mobile device such as a mobile phone. Also, the entire data frame animation environment (200) could reside on a single device, or it could be distributed over multiple devices. For example, the general animation representation generator (220) and the animation representation translator (250) could be hosted on one or more server machines, such as in a Web service, and the rendering environment (270) could be hosted on a client machine that utilizes a browser program for rendering.

The general animation representation generator (220) and an animation representation translator (250) can form a core animation runtime tool that can process animation representations and pass specific animation representations to corresponding rendering environments (270) that are configured to process the specific animation representations (260).

B. Incremental Updates and Delta Frames

As noted above, the general animation representation (220) can represent changes that occur to graphical elements in the animation over time. This may be done by the general animation representation (220) defining sequential graphical frames that each defines all graphical elements of the animation view for a particular point in time. Alternatively, the general animation representation (240) may define key animation frames (242) that each define all the graphical elements of the animation view for a particular point in time. Then, to save computing resources, subsequent animation frames (including frames between key frames (242)), or delta animation frames (244), can each define a graphical view by defining graphical features (such as properties of graphical elements) that have changed from the previous view.

The delta animation frames (244 and 264) can represent changed graphical elements that directly represent the data (bars on bar charts, graph lines, graphical elements that are sized to represent data quantities, etc.), as well as background graphical elements (chart axes, labels, titles, etc.). It can be inferred that other graphical elements not represented in the delta animation frame (244 or 264) will remain unchanged from the previous animation frame. Similar key animation frames (262) and delta animation frames (264) may also be used in the specific animation representation (260) to the extent that the features of the delta frames are supported in the specific language of the specific animation representation (260). To determine what graphical elements have changed from one animation frame to another, the general animation representation generator (220) can maintain a mapping of animation graphical elements to data fields in the data frames (210). Accordingly, if the underlying data for a graphical element has not changed, then the general animation representation generator (220) need not include information on corresponding graphical elements in the next delta animation frame (244). Similarly, if the changes in the data from one data frame (210) to another data frame (210) can be illustrated without changing the background graphical elements, then new information on those background graphical elements can be omitted from the next delta animation frame (244). For example, if the axes from the previous animation frame are sufficient for the data values in the next data frame (210), then the axes can remain the same and information on the axes can be omitted from the next delta animation frame (244). However, if, for example, the data values in the next data frame (210) exceed the limits of the existing axes, then the next delta animation frame (244) can define new axes with values that are large enough to handle representations of the new data values. It should be noted that the animation may not be a chart, and the background graphical elements may be other types of elements. For example, the animation could be a data driven map of a country that displays population census data by state or province in that country. In one implementation, the color of each state or province could be represented by a range of colors depending upon the size of the population. The animation could represent 100 years of animated population data, with the color of individual states/provinces changing to indicate the corresponding change in population during each decade.

If the animation is to perform a seek operation to go to a specified point in the animation or is to rewind to a specified previous point in the animation, and there is a delta animation frame (264) in the specific animation representation (260) at that point, the animation can go to a key animation frame (262) that precedes the specified point, and can play forward to the delta animation frame (264) at the specified point in the animation.

C. Batching Data and Animation Frames

In some situations where there are a finite number of data frames (210) to be processed, all the data frames (210) can be processed prior to rendering any of the corresponding animation graphics, and the entire specific animation representation (260) can be sent together to the rendering environment (270). However, for large sets of data frames (210), or where the set of data frames (210) to be processed is unbounded (such as where the data frames (210) are being streamed to the general animation representation generator (220)), it can be beneficial to process the data frames (210) in batches and to send the corresponding batched portions of the specific animation representation (260) to the rendering environment (270) for rendering while other data frames (210) are still being processed by the general animation representation generator (220) and the animation representation translator (250). The rendering environment (270) can render the batched portions of the specific animation representation (260) as those batched portions are received.

D. Data Frame Animation Implementation

A specific example of an implementation of some tools and techniques for data frame animation will now be described.

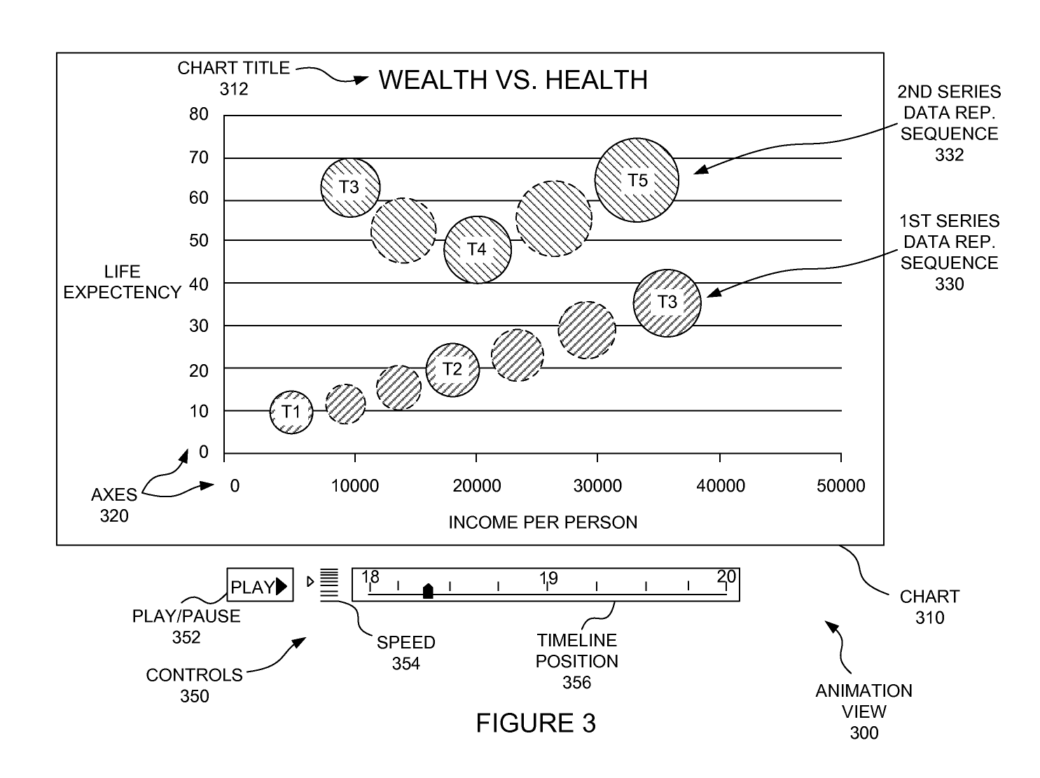

Referring now to FIG. 3, an example of an animation view (300) is illustrated. The animation view (300) is a user interface display of a rendered animation, such as the animations discussed above. The animation view (300) can include a data-driven chart (310). The chart (310) can include a chart title (312), axes (320), a first series data representation sequence (330), and a second series data representation sequence (332). In this example, the chart can represent information about countries. The axes (320) can include a horizontal axis representing income per person in a country and a vertical axis representing life expectancy in a country. The first series data representation sequence (330) represents a first country as a dot positioned in the chart with cross hatching in one direction, and the second series data representation sequence (332) represents a second country as a dot positioned in the chart with cross hatching in a different direction (instead of different directions of cross hatching, different colors or some other difference in appearance could be used). The size and position of the dots can change over time to represent changes in the characteristics of the corresponding countries over time. For example, the size of the dot can represent the population of the country, and the position of the dot relative to the axes (320) can represent the income per person and the life expectancy in the country.

In the illustration of FIG. 2, multiple dots are illustrated for each data representation sequence (330). This is to illustrate how the dots can change over time when the animation of the chart (310) is played. For example, the indicators T(N) (T1, T2, T3, T4, and T5) indicate that the dot corresponds to a data frame N in the sequence of underlying data frames. Dots may be added to the chart (310) as data for the corresponding sequence becomes available. Also, dots may be removed from the chart (310) as data for the corresponding sequence becomes unavailable. For example, with countries, data may have only been collected for that country during part of the overall time period being represented (for example, this may occur where a country only existed during part of the time period). The underlying data frames can each include data corresponding to the representations of the chart (population, income per person, life expectancy, all at a given time). The dots with dashed lines can be interpolated representations based upon time between data frames. These interpolated representations can allow the movement of the animation to be smoother than if only representations of actual data frames were shown. The interpolations for these representations may be performed in different manners with different types of interpolations. Referring to FIG. 2, as an example, the general animation generator (220) could perform the interpolations and include the results in the general animation representation (240). Alternatively, the interpolations could be performed by the animation representation translator (250), or by the rendering environment (270).

Referring back to FIG. 3, the animation view (300) can also include controls (350) for the chart (310). For example, the controls (350) can include a play/pause button (352) that can toggle between “play” (when the animation is not currently playing) and pause (when the animation is currently playing). The controls (350) can also include a speed control (354), which can include an indicator for controlling the speed of the animation in the chart (310), which can result in altering the time between frames. The controls (350) can also include a progress bar (356), which can include an indicator to track the current position of the animation of the chart (310) within the animation sequence. Additionally, the indicator on the progress bar (356) can be moved in response to user input (e.g., dragging and dropping the indicator) to seek to a specific point within the animation.

E. Example Implementation of Using the General Language

Referring back to FIG. 2, in one example, the general animation representation (240) can be written in a general language. The general language may allow timelines and animation actions to be specified.

The animation actions may cover various graphics scenarios. For example, one action may be creating a shape, and another may be destroying a shape. The creation could also include defining shape properties, including an identification that can be referenced by subsequent actions on the shape. Another action could manipulate or transform one or more shape properties. For example, such manipulation could include transforming from one shape to another, changing color, changing shape size, changing shape orientation, changing shape position, etc. Manipulations of shapes could also include interpolating between actions. For example, an interpolation action could specify initial and final values of manipulated properties, as well as one or more clock values for the manipulation. The interpolation could be performed between these initial and final properties (e.g., between an initial and final size, between an initial and final position, etc.). Different specific interpolation rules may be applied to different types of animation actions, and the specifying an action may include specifying at least a portion of the interpolation rules to be used for interpolation rules to be applied to that action.

As noted above, the general language may also allow for the use of timelines that can govern the execution of animation actions. In one example, a root timeline may be specified for each animation. The root timeline can manage the clock for the animation, and can drive the overall animation sequence, including managing child timelines. In one example, the range of the clock can be defined by the number of key frames, and the clock rate can be defined by the speed (e.g., in frames per second). Also, a clock rate of infinity can result in only key frames being displayed, and no interpolations between the key frames (the clock value to child timelines for each clock tick can be a value of zero). The root timeline can be manipulated by controls such as the controls (350) discussed above with reference to FIG. 3 (play, pause, seek, speed, etc.).

The root clock can fire clock events to child timelines, and each child timeline can control one or more animation actions. The beginning and end times of the child timeline can be specified relative to the root timeline, and the child timeline can receive clock tick values from the root timeline. A child timeline can translate the root timeline clock tick values to relative values between two values, such as zero and one (where the child timeline can start at relative time zero and end at relative time one). The child timeline can fire child timeline clock tick events to the animation actions that are controlled by the child timeline.

F. Example Runtime Technique Implementation

An example of techniques to be performed for an animation at runtime will now be discussed, although different techniques could be used. The runtime technique can include view validation, and translation/rendering. All or part of both of these acts can be performed on the same computing machine or on different computing machines. These techniques will be discussed with reference to a data-driven chart, but similar techniques could be used for other types of animations that derive from data frames.

During view validation, a chart object can create a data driven root view element and attach it to a view. The chart object can scan through all key frames to determine minimum and maximum values to use for the chart's axes. A root timeline can be created, and can be attached to the root view element.

The chart object can also create root timeline controls. For example, this creation may include creating a child timeline with a start time, and attaching the child timeline to the root timeline at the start time. A create animation action for a play control, a create animation action for a speed control, and a create animation action for a progress bar can all be attached to the child timeline.

The chart object can also create shapes for static graphics on the chart. For example, this can include creating a child timeline for the static graphics and attaching that child timeline to the root timeline at a start time for the child timeline. Create animation actions for each of the static graphics (e.g., chart title, plot area, gridlines, axes, and axis labels) can be generated with the properties for the graphics, and those create animation actions can each be attached to the child timeline for static graphics.

Additionally, the chart object can iterate through the collections of key data frames and perform the following for each data frame: create a child timeline and attach the child timeline to the root timeline at a start time for the child timeline; for each new shape, attach a create animation action with properties for the shape to the child timeline; for each existing shape that is going away, attach a destroy animation action with the shape identification to the child timeline; and for each continuing shape that will be changed, attach a transform or manipulate animation action with the shape identification and initial and final property values to the child timeline.

The translation/rendering can be done differently for local applications than for a browser scenario. For both scenarios, the root view element can parse the root timeline. For the local application scenario, as the timeline is parsed, for each child timeline with a current start time, each associated animation action for the child timeline can be processed. This processing can include translating the animation actions into representations that are specific to the rendering environment. For example, if the rendering is to be done with a spreadsheet program, the animation actions can be translated into a specific language (which could actually include information in one or more languages) that is understood by the spreadsheet program. Similarly, if the rendering is to be done by a database program or a word processing program, the animation action can be translated into a specific language that can be understood by that program (which again may be one or more languages, such as in Java script and HTML). The translated specific representations can be provided to a rendering engine, such as by being passed within a program, or being passed to a program through an application programming interface.

For the browser scenario, the root and child timelines and their association animation actions can be translated into a payload in a specific language that can be understood and processed by the browser. Each payload can be sent to the browser as the payload is completely generated, and the browser can process the payloads as the payloads arrive, even if all payloads have not yet arrived. Besides the browser scenario and the local application scenario discussed above, other scenarios could work similarly. For example, there could be a dedicated device, such as a handheld device, for processing the frames and performing the animation. The representations could be sent over a network without using a browser at the receiving end (e.g., where a dedicated animation device without a browser receives the representations and renders the animations). Also, different scenarios could involve different types of devices, such as slate devices, mobile phones, desktop computers, laptop computers, etc. It should be noted that the local application could use the mechanism described above for a remote browser scenario, and a remote browser scenario could use the mechanism described above for the local application.

The environment (200) may use the general animation representation (240) and the specific animation representation (260), as discussed above. Alternatively, the environment (200) may generate an animation representation and send that representation to the rendering environment, without translating between a general animation representation and a specific animation representation.

III. Techniques for Multi-Source Data Frame Animation and/or Data Frame Animation with Delta Frames

Several techniques for multi-source data frame animation and/or data frame animation with delta frames will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable storage media may have computer-executable instructions embodied thereon that, when executed by at least one processor, cause at least one processor to perform the technique.

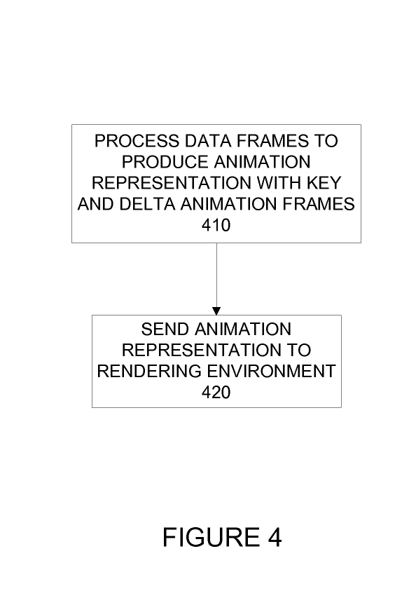

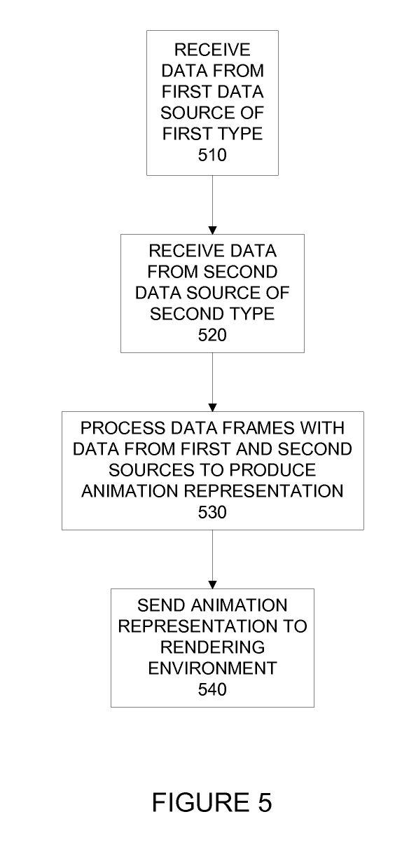

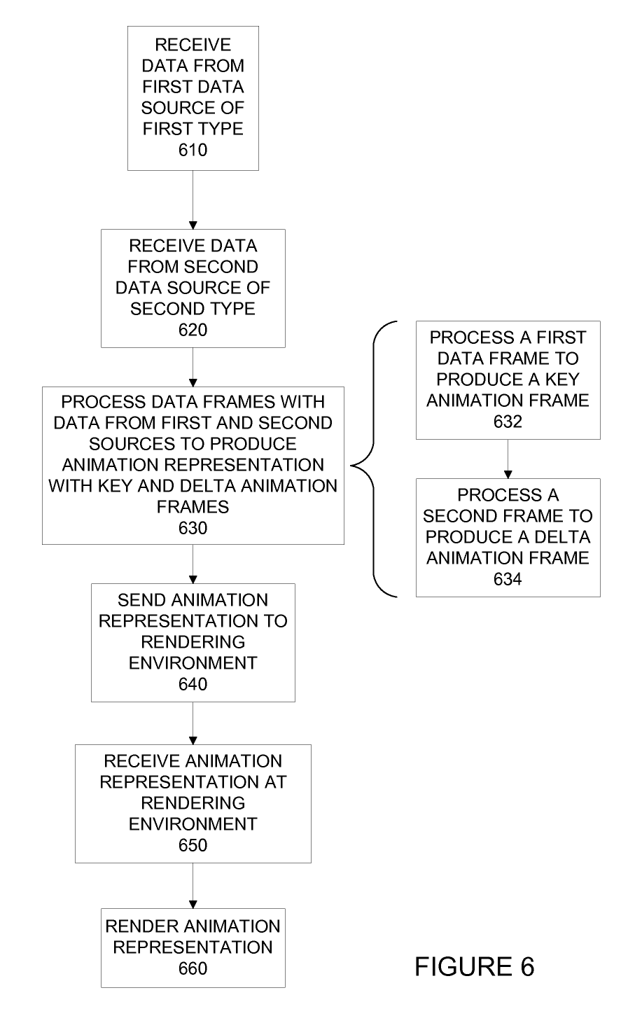

Referring to FIG. 4, a technique for data frame animation with delta animation frames will be described. The technique can include processing (410) data frames to produce an animation representation that represents the frames of data. This processing (410) of data frames, and similar processing discussed below with reference to FIGS. 5-6, may include translating all or part of an animation representation into another form, as discussed above. The animation representation can include one or more key animation frames that each defines a full graphical representation of one of the data frames and one or more delta animation frames that each defines one or more graphical updates without defining a full graphical representation of one of the data frames.

Processing (410) the data frames can include processing a first frame of data to produce a key animation frame that defines a full graphical representation of the first frame of data. Processing (410) the data frames can also include processing a second frame of data to produce a delta animation frame that defines one or more graphical updates to represent the second frame of data without defining a full graphical representation of the second frame of data. For example, the graphical representation of the second frame of data can be defined by a combination of information that can include the delta animation frame and the key animation frame. Processing the second frame of data can include identifying one or more graphical elements of the animation representation to update as a result of one or more data changes between the first and second data frames. Processing the second frame of data can also include identifying one or more graphical elements of the animation representation to refrain from updating as a result of one or more data similarities between the first and second data frames. Identifying the graphical elements to update or refrain from updating can include comparing one or more values in one or more data fields in the first and second data frames, and matching the data field(s) with one or more graphical elements of the animation representation. The matching can include accessing a mapping of one or more data fields in the first and second data frames to one or more graphical elements of the animation representation. The graphical element(s) to refrain from updating and the graphical elements to update may each include one or more graphical elements representing one or more values in the first data frame and the second data frame and/or one or more background graphical elements (such as one or more axes in a chart).

The technique of FIG. 4 can include sending (420) the animation representation to a rendering environment. The technique may also include receiving the animation representation at the rendering environment and rendering the animation representation on a display device. The animation representation may change forms before, during, or after being sent to the rendering environment (e.g., by being translated from a general animation representation into a specific animation representation) and still be considered the same animation representation, unless different forms of the animation representation are recited (e.g., by reciting a general animation representation and a specific animation representation).

Referring now to FIG. 5, a technique for multi-source data frame animation will be discussed. The technique can include receiving (510) data from a first data source that is a first type of data source, and receiving (520) data from a second data source that is a second type of data source. The technique can also include processing (530) data frames that include the data from the first data source and the data from the second data source, to produce an animation representation that represents the data frames. The animation representation can be sent (540) to a rendering environment.

One of the data frames can include data from the first data source and data from the second data source. That frame can be termed a first frame, and a second frame of the data frames can also include data from the first data source and data from the second data source. The animation representation can define a graphical element that represents one or more values from data from the first data source and one or more values from the data from the second data source. For example, a position of a graphical element could represent a value (e.g., population value) from one data source and a color of the graphical element could represent a value (e.g., the name of a country) from another data source. Also, the animation representation can include one or more key animation frames that each defines a full graphical representation of one of the data frames and one or more delta animation frames that each defines one or more graphical updates without defining a full graphical representation.

The technique of FIG. 5 may further include receiving the animation representation at the rendering environment, and rendering the animation representation on a display device.

Referring now to FIG. 6, a technique for multi-source data frame animation with delta frames will now be discussed. The technique can include receiving (610) data from a first data source that is a first type of data source, and receiving (620) data from a second data source that is a second type of data source. The technique can also include processing (630) data frames that include the data from the first data source and the data from the second data source to produce an animation representation that represents the data frames. The animation representation can include one or more key animation frames that each defines a full graphical representation of one of the data frames and one or more delta animation frames that each defines one or more graphical updates without defining a full graphical representation. Processing (630) the data frames can include processing (632) a first frame of data to produce a key animation frame that defines a full graphical representation of the first frame of data, and processing (634) a second frame of data to produce a delta animation frame that defines one or more graphical updates to represent the second frame of data without defining a full graphical representation of the second frame of data. Processing (634) the second frame can include identifying one or more graphical elements of the animation representation to update as a result of one or more data changes between the first and second data frames, and identifying one or more graphical elements of the animation representation to refrain from updating as a result of one or more data similarities between the first and second data frames. The animation representation can be sent (640) to a rendering environment.

Identifying one or more graphical elements to update and one or more graphical elements to refrain from updating can include accessing a mapping of one or more data fields in the first and second data frames to one or more graphical elements of the animation representation. The mapping can be accessed to compare values in one or more data fields in the first and second data frames and to match the one or more data fields with one or more graphical elements of the animation representation.

A frame of the data frames can include data from the first data source and data from the second data source. Also, the animation representation can define a graphical element that represents one or more values from the data from the first data source and one or more values from the data from the second data source.

The technique of FIG. 6 can also include receiving (650) the animation representation at the rendering environment, and rendering (660) the animation representation on a display device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. A computer-implemented method, comprising:
processing data frames to produce an animation representation that represents the data frames, the animation representation comprising one or more key animation frames that each defines a full graphical representation of one of the data frames and one or more delta animation frames that each defines one or more graphical updates without defining a full graphical representation of one of the data frames; and
sending the animation representation to a rendering environment.

2. The method of claim 1, wherein processing the data frames comprises:
processing a first frame of data to produce a key animation frame that defines a full graphical representation of the first frame of data; and
processing a second frame of data to produce a delta animation frame that defines one or more graphical updates to represent the second frame of data without defining a full graphical representation of the second frame of data.

3. The method of claim 2, wherein processing the second frame of data comprises:
identifying one or more graphical elements of the animation representation to update as a result of one or more data changes between the first and second data frames; and
identifying one or more graphical elements of the animation representation to refrain from updating as a result of one or more data similarities between the first and second data frames.

4. The method of claim 3, wherein identifying one or more graphical elements to update and identifying one or more graphical elements to refrain from updating comprises:
comparing one or more values in one or more data fields in the first and second data frames; and
matching the one or more data fields with one or more graphical elements of the animation representation.

5. The method of claim 4, wherein matching comprises accessing a mapping of one or more data fields in the first and second data frames to one or more graphical elements of the animation representation.

6. The method of claim 3, wherein the one or more graphical elements to refrain from updating comprise one or more graphical elements representing one or more values in the first data frame and the second data frame.

7. The method of claim 3, wherein the one or more graphical elements to refrain from updating comprise one or more background graphical elements.

8. The method of claim 7, wherein the one or more background graphical elements comprise one or more axes in a chart.

9. One or more computer-readable storage media having computer-executable instructions embodied thereon that, when executed by at least one processor, cause at least one processor to perform acts comprising:
receiving data from a first data source that is a first type of data source;
receiving data from a second data source that is a second type of data source;
processing data frames comprising the data from the first data source and the data from the second data source to produce an animation representation that represents the data frames; and
sending the animation representation to a rendering environment.

10. The one or more computer-readable storage media of claim 9, wherein a frame of the data frames comprises data from the first data source and data from the second data source.

11. The one or more computer-readable storage media of claim 10, wherein the frame is a first frame, and wherein a second frame of the data frames comprises data from the first data source and data from the second data source.

12. The one or more computer-readable storage media of claim 9, wherein the animation representation defines a graphical element that represents one or more values from data from the first data source and one or more values from the data from the second data source.

13. The one or more computer-readable storage media of claim 12, wherein the animation representation defines graphical elements that each represents one or more values from data from the first data source and one or more values from the data from the second data source.

14. The one or more computer-readable storage media of claim 9, wherein the animation representation comprises one or more key animation frames that each defines a full graphical representation of one of the data frames and one or more delta animation frames that each defines one or more graphical updates without defining a full graphical representation.

15. The one or more computer-readable storage media of claim 9, wherein the acts further comprise:
receiving the animation representation at the rendering environment; and
rendering the animation representation on a display device.

16. A computer system comprising:
at least one processor; and
memory comprising instructions stored thereon that when executed by at least one processor cause at least one processor to perform acts comprising:
receiving data from a first data source that is a first type of data source;
receiving data from a second data source that is a second type of data source;
processing data frames comprising the data from the first data source and the data from the second data source to produce an animation representation that represents the data frames, the animation representation comprising one or more key animation frames that each defines a full graphical representation of one of the data frames and one or more delta animation frames that each defines one or more graphical updates without defining a full graphical representation, processing the data frames comprising:
processing a first frame of data to produce a key animation frame that defines a full graphical representation of the first frame of data; and
processing a second frame of data to produce a delta animation frame that defines one or more graphical updates to represent the second frame of data without defining a full graphical representation of the second frame of data, processing the second frame comprising identifying one or more graphical elements of the animation representation to update as a result of one or more data changes between the first and second data frames and identifying one or more graphical elements of the animation representation to refrain from updating as a result of one or more data similarities between the first and second data frames; and
sending the animation representation to a rendering environment.

17. The computer system of claim 16, wherein the acts further comprise:
receiving the animation representation at the rendering environment; and
rendering the animation representation on a display device.

18. The computer system of claim 16, wherein identifying one or more graphical elements to update and one or more graphical elements to refrain from updating comprises accessing a mapping of one or more data fields in the first and second data frames to one or more graphical elements of the animation representation to perform the following:
compare values in one or more data fields in the first and second data frames; and
match the one or more data fields with one or more graphical elements of the animation representation.

19. The computer system of claim 16, wherein a frame of the data frames comprises data from the first data source and data from the second data source.

20. The computer system of claim 19, wherein the animation representation defines a graphical element that represents one or more values from the data from the first data source and one or more values from the data from the second data source.
